(19) United States
(12) Patent Application Publication
(10) Pub. No.: US 2019/0109652 A1
(43) Pub. Date: Apr. 11, 2019

(54) METHOD FOR REMOVING SELF-INTERFERENCE SIGNAL IN FDR ENVIRONMENT AND COMMUNICATION APPARATUS FOR SAME

(71) Applicant: LG ELECTRONICS INC., Seoul (KR)

(72) Inventors: Dongkyu KIM, Seoul (KR); Kwangseok NOH, Seoul (KR); Sangrim LEE, Seoul (KR); Hojae LEE, Seoul (KR)

(73) Assignee: LG ELECTRONICS INC., Seoul (KR)

(21) Appl. No.: 16/086,300

(22) PCT Filed: Jul. 27, 2016
(86) PCT No.: PCT/KR2016/008250

§ 371 Date: Sep. 18, 2018

Related U.S. Application Data
(60) Provisional application No. 62/309,974, filed on Mar. 18, 2016.

(51) Int. Cl. H04B 15/02; H04L 5/14; H04J 11/00

(52) U.S. Cl. CPC H04B 15/02; H04J 11/0023; H04L 5/14

(57) ABSTRACT

A communication apparatus for eliminating a self-interference signal in an FDR environment comprises: a distributor for distributing signals from a transmission chain to a plurality of lines in a receiving chain; a first self-interference signal replicating unit for generating a self-interference replica signal of a signal distributed to a first line from among the plurality of lines by the distributor; a second self-interference signal replicating unit for generating a self-interference replica signal of a signal distributed to a second line from among the plurality of lines by the distributor; and a self-interference eliminating unit for eliminating self-interference by deducting, from the signals distributed by the distributor, a signal generated by the first self-interference signal replicating unit and a signal generated by the second self-interference signal replicating unit.

### TECHNICAL FIELD

The present invention relates to a wireless communication, and more particularly, to a method of canceling a self-interference signal in FDR environment and a communication device therefor.

### BACKGROUND ART

Compared to conventional half duplex communication in which time or frequency resources are divided orthogonally, full duplex communication doubles a system capacity in theory by allowing a node to perform transmission and reception simultaneously.

FIG. 1 is a conceptual view of a UE and a Base Station (BS) which support Full Duplex Radio (FDR).

In the FDR situation illustrated in FIG. 1, the following three types of interference are produced.

Intra-Device Self-Interference:

Because transmission and reception take place in the same time and frequency resources, a desired signal and a signal transmitted from a BS or UE are received at the same time at the BS or UE. The transmitted signal is received with almost no attenuation at a Reception (Rx) antenna of the BS or UE, and thus with much larger power than the desired signal. As a result, the transmitted signal serves as interference.

UE to UE Inter-Link Interference:

An Uplink (UL) signal transmitted by a UE is received at an adjacent UE and thus serves as interference.

BS to BS Inter-Link Interference:

The BS to BS inter-link interference refers to interference caused by signals that are transmitted between BSs or heterogeneous BSs (pico, femto, and relay) in a HetNet state and received by an Rx antenna of another BS.

Among such three types of interference, intra-device self-interference (hereinafter, self-interference (SI)) is generated only in an FDR system to significantly deteriorate performance of the FDR system. Therefore, first of all, intra-device SI needs to be cancelled in order to operate the FDR system.

### DISCLOSURE OF THE INVENTION

### Technical Tasks

A technical task of the present invention is to provide a communication device capable of canceling a self-interference signal in FDR environment.

Another technical task of the present invention is to provide a method for a communication device to cancel a self-interference signal in FDR environment.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a communication device canceling a self-interference signal in FDR (Full Duplex Radio) environment includes a distributor configured to distribute signals from a transmission chain to a reception chain via a plurality of lines, a first self-interference signal replication unit configured to generate a self-interference replication signal for the signal distributed via a first line by the distributor among a plurality of the lines, a second self-interference signal replication unit configured to generate a self-interference replication signal for the signal distributed via a second line by the distributor among a plurality of the lines, and a self-interference cancellation unit configured to perform self-interference cancellation in a manner of subtracting a signal generated by the first self-interference signal replication unit and a signal generated by the second self-interference signal replication unit from the signals distributed by the distributor.

Each of the first self-interference signal replication unit and the second self-interference signal replication unit of the communication device includes an attenuator, a phase shifter, and a true time delay and a time delay value of a true time delay included in the first self-interference signal replication unit is different from a time delay value of a true time delay included in the second self-interference signal replication unit.

The communication device can further include a processor configured to determine whether to replicate a plurality of self-interference signals for the signals distributed via a plurality of the lines. The processor may determine based on whether or not the FDR environment corresponds to a frequency selective fading channel characteristic.

The communication device may further include the transmission chain configured to transmit multiple tones. In this case, the processor may determine whether to replicate a plurality of the self-interference signals based on channel measurement for the multiple tones.

To further achieve these and other advantages and in accordance with the purpose of the present invention, according to a different embodiment, a method for canceling a self-interference signal by a communication device in FDR (Full Duplex Radio) environment, includes distributing signals from a transmission chain to a reception chain of an RF end via a plurality of lines, performing attenuation, phase shift, and time delay on the distributed signals in a first line among a plurality of the lines, performing attenuation, phase shift, and time delay on the distributed signals in a second line among a plurality of the lines, and performing self-interference cancellation in a manner of subtracting a first signal on which the attenuation, the phase shift, and the time delay are performed and a second signal on which the attenuation, the phase shift, and the time delay are performed from the distributed signals. A value of the time delay in the first line is different from a value of the time delay in the second line.

The method may further include determining whether the attenuation, the phase shift, and the time delay are performed on the distributed signal in a plurality of the lines or a single line. The determining may be performed based on whether the FDR environment corresponds to a frequency selective fading channel characteristic. Whether the FDR environment corresponds to the frequency selective fading channel characteristic can be determined based on channel measurement performed on multiple tones transmitted by the communication device.

### Advantageous Effects

According to one embodiment of the present invention, when a frequency selective characteristic of self-interference occurs according to channel environment or a frequency selective characteristic of self-interference occurs over a wideband, it is able to efficiently cancel the self-interference, thereby considerably improving communication performance in FDR environment.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram illustrating a network supporting a full-duplex/half-duplex communication operation of a UE proposed by the present invention;

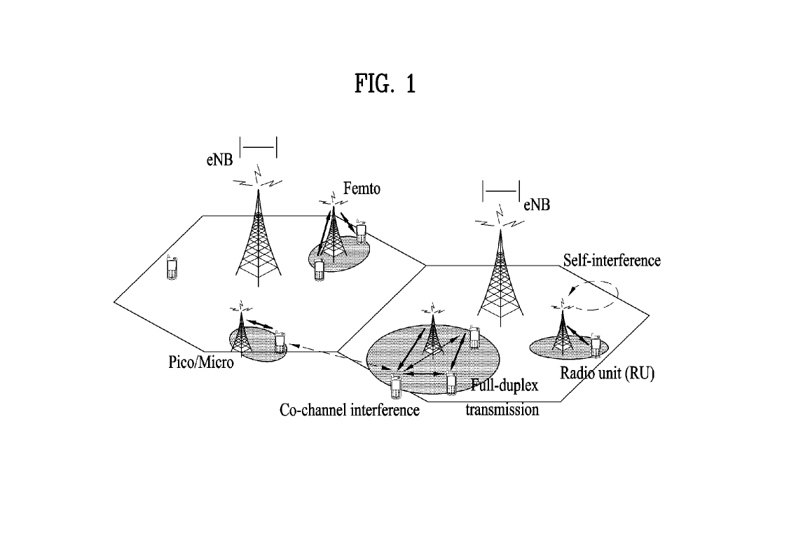

FIG. 2 is a block diagram illustrating configurations of a base station 105 and a user equipment 110 in a wireless communication system 100;

FIG. 3 is a conceptual diagram illustrating a transmission/reception link and self-interference (SI) in an FDR communication situation;

FIG. 4 is a diagram illustrating positions to which three interference schemes are applied at an RF transmission/reception end (or RF front end) of a device;

FIG. 5 is a block diagram illustrating a device for canceling self-interference in a communication device proposed in communication system environment using OFDM based on FIG. 4;

FIG. 6 is a diagram illustrating an example of an RF front-end structure, when a true time delay, a phase shifter, and an attenuator are connected in series to cancel self-interference in analog domain;

FIG. 7 is a diagram illustrating changing characteristics of a size and a phase according to changes of an attenuator, a phase shifter, and a true time delay;

FIG. 8 is a diagram illustrating isolation phase (deg) and isolation group delay (ns) in multi-path channel environment;

FIG. 9 is a diagram illustrating changes of a size and a phase according to a frequency change and self-interference cancellation (SIC) performance, when a rat race coupler (RRC) is used;

FIG. 10 is a diagram illustrating an example for a case of configuring a plurality of analog signals having a different delay value and an example of self-interference cancellation performance.

### BEST MODE

### Mode for Invention

Reference will now be made in detail to the preferred embodiments of the present invention, examples of which are illustrated in the accompanying drawings. In the following detailed description of the invention includes details to help the full understanding of the present invention. Yet, it is apparent to those skilled in the art that the present invention can be implemented without these details. For instance, although the following descriptions are made in detail on the assumption that a mobile communication system includes 3GPP LTE system, the following descriptions are applicable to other random mobile communication systems in a manner of excluding unique features of the 3GPP LTE.

Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same or like parts.

Besides, in the following description, assume that a terminal is a common name of such a mobile or fixed user stage device as a user equipment (UE), a mobile station (MS), an advanced mobile station (AMS) and the like. And, assume that a base station (BS) is a common name of such a random node of a network stage communicating with a terminal as a Node B (NB), an eNode B (eNB), an access point (AP) and the like. Although the present specification is described based on IEEE 802.16m system, contents of the present invention may be applicable to various kinds of other communication systems.

In a mobile communication system, a user equipment is able to receive information in downlink and is able to transmit information in uplink as well. Information transmitted or received by the user equipment node may include various kinds of data and control information. In accordance with types and usages of the information transmitted or received by the user equipment, various physical channels may exist.

The following descriptions are usable for various wireless access systems including CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented by such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc. UTRA is a part of UMTS (Universal Mobile Telecommunications System). 3GPP (3rd Generation Partnership Project) LTE (long term evolution) is a part of E-UMTS (Evolved UMTS) that uses E-UTRA. The 3GPP LTE employs OFDMA in DL and SC-FDMA in UL. And, LTE-A (LTE-Advanced) is an evolved version of 3GPP LTE.

Moreover, in the following description, specific terminologies are provided to help the understanding of the present invention. And, the use of the specific terminology can be modified into another form within the scope of the technical idea of the present invention.

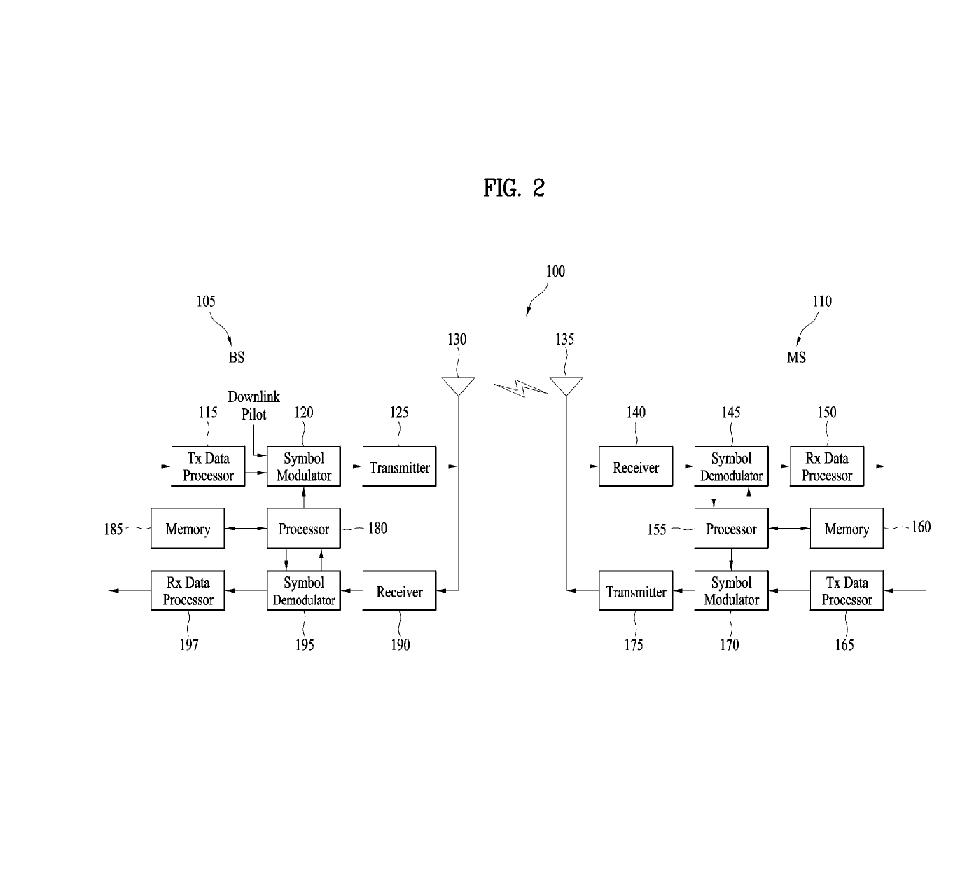

FIG. 2 is a block diagram for configurations of a base station 105 and a user equipment 110 in a wireless communication system 100.

Although one base station 105 and one user equipment 110 (D2D user equipment included) are shown in the drawing to schematically represent a wireless communication system 100, the wireless communication system 100 may include at least one base station and/or at least one user equipment.

Referring to FIG. 2, a base station 105 may include a transmitted (Tx) data processor 115, a symbol modulator 120, a transmitter 125, a transceiving antenna 130, a processor 180, a memory 185, a receiver 190, a symbol demodulator 195 and a received data processor 197. And, a user equipment 110 may include a transmitted (Tx) data processor 165, a symbol modulator 170, a transmitter 175, a transceiving antenna 135, a processor 155, a memory 160, a receiver 140, a symbol demodulator 155 and a received data processor 150. Although the base station/user equipment 105/110 includes one antenna 130/135 in the drawing, each of the base station 105 and the user equipment 110 includes a plurality of antennas. Therefore, each of the base station 105 and the user equipment 110 of the present invention supports an MIMO (multiple input multiple output) system. And, the base station 105 according to the present invention may support both SU-MIMO (single user-MIMO) and MU-MIMO (multi user-MIMO) systems.

In downlink, the transmitted data processor 115 receives traffic data, codes the received traffic data by formatting the received traffic data, interleaves the coded traffic data, modulates (or symbol maps) the interleaved data, and then provides modulated symbols (data symbols). The symbol modulator 120 provides a stream of symbols by receiving and processing the data symbols and pilot symbols.

The symbol modulator 120 multiplexes the data and pilot symbols together and then transmits the multiplexed symbols to the transmitter 125. In doing so, each of the transmitted symbols may include the data symbol, the pilot symbol or a signal value of zero. In each symbol duration, pilot symbols may be contiguously transmitted. In doing so, the pilot symbols may include symbols of frequency division multiplexing (FDM), orthogonal frequency division multiplexing (OFDM), or code division multiplexing (CDM).

The transmitter 125 receives the stream of the symbols, converts the received stream to at least one or more analog signals, additionally adjusts the analog signals (e.g., amplification, filtering, frequency upconverting), and then generates a downlink signal suitable for a transmission on a radio channel. Subsequently, the downlink signal is transmitted to the user equipment via the antenna 130.

In the configuration of the user equipment 110, the receiving antenna 135 receives the downlink signal from the base station and then provides the received signal to the receiver 140. The receiver 140 adjusts the received signal (e.g., filtering, amplification and frequency downconverting), digitizes the adjusted signal, and then obtains samples. The symbol demodulator 145 demodulates the received pilot symbols and then provides them to the processor 155 for channel estimation.

The symbol demodulator 145 receives a frequency response estimated value for downlink from the processor 155, performs data demodulation on the received data symbols, obtains data symbol estimated values (i.e., estimated values of the transmitted data symbols), and then provides the data symbols estimated values to the received (Rx) data processor 150. The received data processor 150 reconstructs the transmitted traffic data by performing demodulation (i.e., symbol demapping, deinterleaving and decoding) on the data symbol estimated values.

The processing by the symbol demodulator 145 and the processing by the received data processor 150 are complementary to the processing by the symbol modulator 120 and the processing by the transmitted data processor 115 in the base station 105, respectively.

In the user equipment 110 in uplink, the transmitted data processor 165 processes the traffic data and then provides data symbols. The symbol modulator 170 receives the data symbols, multiplexes the received data symbols, performs modulation on the multiplexed symbols, and then provides a stream of the symbols to the transmitter 175. The transmitter 175 receives the stream of the symbols, processes the received stream, and generates an uplink signal. This uplink signal is then transmitted to the base station 105 via the antenna 135.

In the base station 105, the uplink signal is received from the user equipment 110 via the antenna 130. The receiver 190 processes the received uplink signal and then obtains samples. Subsequently, the symbol demodulator 195 processes the samples and then provides pilot symbols received in uplink and a data symbol estimated value. The received data processor 197 processes the data symbol estimated value and then reconstructs the traffic data transmitted from the user equipment 110.

The processor 155/180 of the user equipment/base station 110/105 directs operations (e.g., control, adjustment, management, etc.) of the user equipment/base station 110/105. The processor 155/180 may be connected to the memory unit 160/185 configured to store program codes and data. The memory 160/185 is connected to the processor 155/180 to store operating systems, applications and general files.

The processor 155/180 may be called one of a controller, a microcontroller, a microprocessor, a microcomputer and the like. And, the processor 155/180 may be implemented using hardware, firmware, software and/or any combinations thereof. In the implementation by hardware, the processor 155/180 may be provided with such a device configured to implement the present invention as ASICs (application specific integrated circuits), DSPs (digital signal processors), DSPDs (digital signal processing devices), PLDs (programmable logic devices), FPGAs (field programmable gate arrays), and the like.

Meanwhile, in case of implementing the embodiments of the present invention using firmware or software, the firmware or software may be configured to include modules, procedures, and/or functions for performing the above-explained functions or operations of the present invention. And, the firmware or software configured to implement the present invention is loaded in the processor 155/180 or saved in the memory 160/185 to be driven by the processor 155/180.

Layers of a radio protocol between a user equipment/base station and a wireless communication system (network) may be classified into 1st layer L1, 2nd layer L2 and 3rd layer L3 based on 3 lower layers of OSI (open system interconnection) model well known to communication systems. A physical layer belongs to the 1st layer and provides an information transfer service via a physical channel. RRC (radio resource control) layer belongs to the 3rd layer and provides control radio resourced between UE and network. A user equipment and a base station may be able to exchange RRC messages with each other through a wireless communication network and RRC layers.

In the present specification, although the processor 155/180 of the user equipment/base station performs an operation of processing signals and data except a function for the user equipment/base station 110/105 to receive or transmit a signal, for clarity, the processors 155 and 180 will not be mentioned in the following description specifically. In the following description, the processor 155/180 can be regarded as performing a series of operations such as a data processing and the like except a function of receiving or transmitting a signal without being specially mentioned.

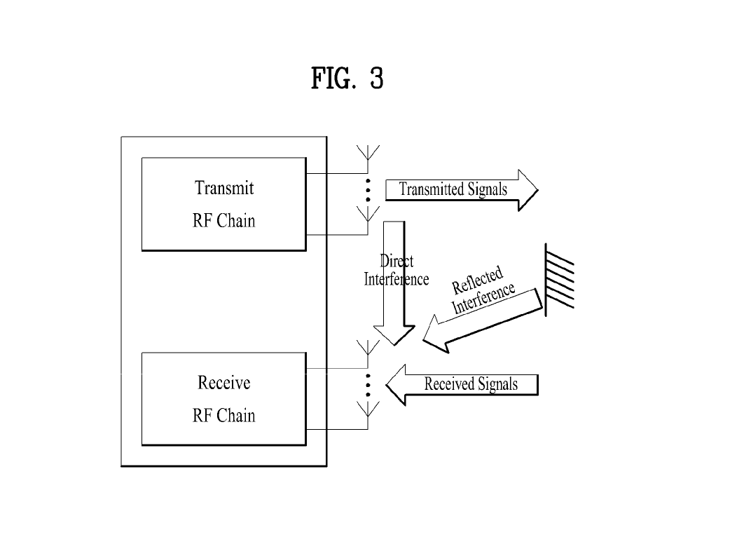

FIG. 3 is a diagram showing the concept of a transmission/reception link and self-interference (SI) in an FDR communication situation.

As shown in FIG. 3, SI may be divided into direct interference caused when a signal transmitted from a transmit antenna directly enters a receive antenna without path attenuation, and reflected interference reflected by peripheral topology, and the level thereof is dramatically greater than a desired signal due to a physical distance difference. Due to the dramatically large interference intensity, efficient SI cancellation is necessary to operate the FDR system.

To effectively operate the FDR system, self-IC requirements with respect to the maximum transmission power of devices (in the case where FDR is applied to a mobile communication system (BW=20 MHz)) may be determined as illustrated in [Table 1] below.

TABLE 1

| | | | | | | Receiver | | |
|---|---|---|---|---|---|---|---|---|
| Node | Max. Tx | Thermal Noise. | | | | Thermal Noise | | Self-IC Target |
| Type | Power (P_{A}) | (BW = 20 MHz) | | Receiver NF | | Level | | (P_{A}- TN-NF) |
| Macro eNB | 46 dBm | 1 | dBm | 5 | dB | −96 | dBm | 142 dB |
| | | | | (for eNB) | | | | |
| Pico eNB | 30 dBm | 126 | dB | | | | | |
| Femto eNB, | 23 dBm | 119 | dB | | | | | |
| WLAN AP | | | | | | | | |
| UE | 23 dBm | 9 | dB | −92 | dBm | 115 | dB | |

(for UE)

Referring to [Table 1], it may be noted that to effectively operate the FDR system in a 20-MHz BW, a UE needs 119-dBm Self-IC performance. A thermal noise value may be changed to N_{0,BW}=−174 dBm+10×log₁₀(BW) according to the BW of a mobile communication system. In [Table 1], the thermal noise value is calculated on the assumption of a 20-MHz BW. In relation to [Table 1], for Receiver Noise Figure (NF), a worst case is considered referring to the 3GPP specification requirements. Receiver Thermal Noise Level is determined to be the sum of a thermal noise value and a receiver NF in a specific BW.

Types of Self-IC Schemes and Methods for Applying the Self-IC Schemes

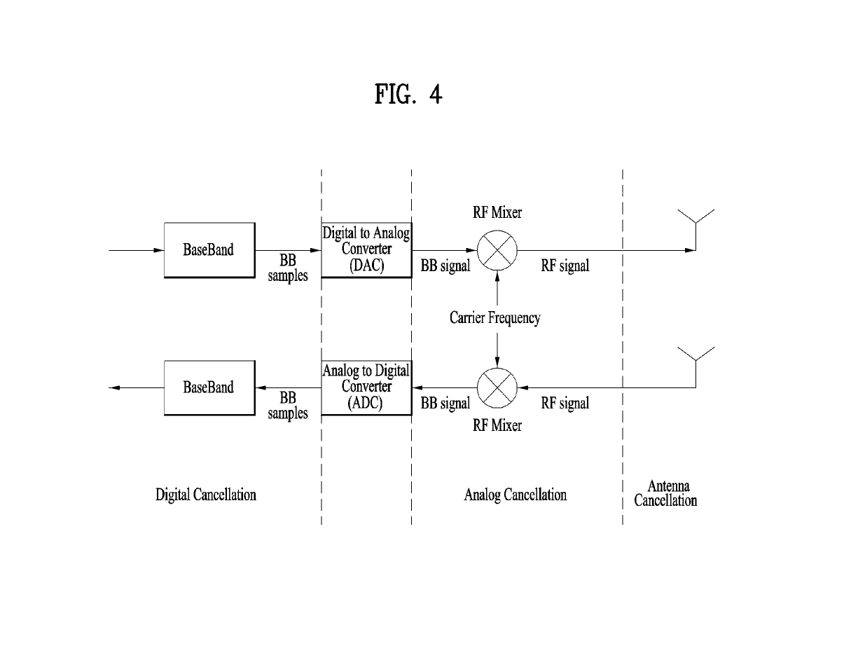

FIG. 4 is a view illustrating positions at which three Self-IC schemes are applied, in a Radio Frequency (RF) Tx and Rx end (or an RF front end) of a device. Now, a brief description will be given of the three Self-IC schemes.

Antenna Self-IC:

Antenna Self-IC is a Self-IC scheme that should be performed first of all Self-IC schemes. SI is cancelled at an antenna end. Most simply, transfer of an SI signal may be blocked physically by placing a signal-blocking object between a Tx antenna and an Rx antenna, the distance between antennas may be controlled artificially, using multiple antennas, or a part of an SI signal may be canceled through phase inversion of a specific Tx signal. Further, a part of an SI signal may be cancelled by means of multiple polarized antennas or directional antennas.

Analog Self-IC:

Interference is canceled at an analog end before an Rx signal passes through an Analog-to-Digital Convertor (ADC). An SI signal is canceled using a duplicated analog signal. This operation may be performed in an RF region or an Intermediate Frequency (IF) region. SI signal cancellation may be performed in the following specific method. A duplicate of an actually received SI signal is generated by delaying an analog Tx signal and controlling the amplitude and phase of the delayed Tx signal, and subtracted from a signal received at an Rx antenna. However, due to the analog signal-based processing, the resulting implementation complexity and circuit characteristics may cause additional distortion, thereby changing interference cancellation performance significantly.

Digital Self-IC:

Interference is canceled after an Rx signal passes through an ADC. Digital Self-IC covers all IC techniques performed in a baseband region. Most simply, a duplicate of an SI signal is generated using a digital Tx signal and subtracted from an Rx digital signal. Or techniques of performing precoding/postcoding in a baseband using multiple antennas so that a Tx signal of a UE or an eNB may not be received at an Rx antenna may be classified into digital Self-IC. However, since digital Self-IC is viable only when a digital modulated signal is quantized to a level enough to recover information of a desired signal, there is a need for the prerequisite that the difference between the signal powers of a designed signal and an interference signal remaining after interference cancellation in one of the above-described techniques should fall into an ADC range, to perform digital Self-IC.

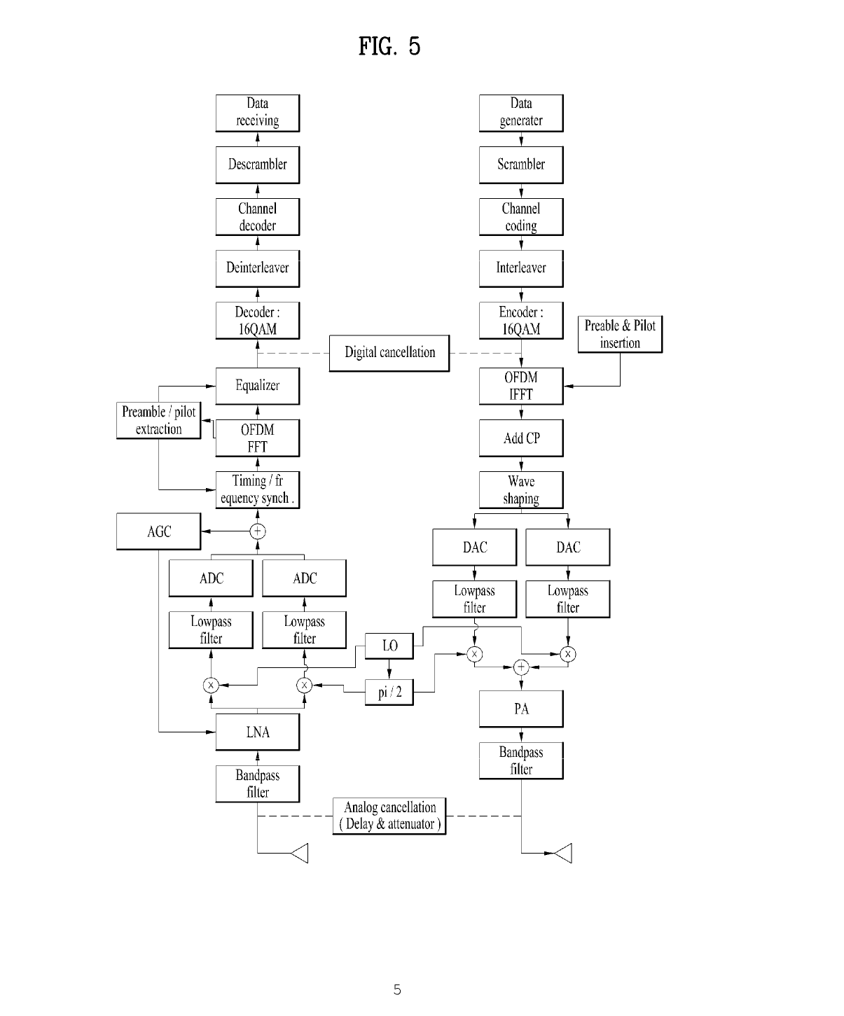

FIG. 5 is a block diagram of a Self-IC device in a proposed communication apparatus in an OFDM communication environment based on FIG. 4.

While FIG. 5 shows that digital Self-IC is performed using digital SI information before Digital to Analog Conversion (DAC) and after ADC, it may be performed using a digital SI signal after Inverse Fast Fourier Transform (IFFT) and before Fast Fourier Transform (FFT). Further, although FIG. 5 is a conceptual view of Self-IC though separation of a Tx antenna from an Rx antenna, if antenna Self-IC is performed using a single antenna, the antenna may be configured in a different manner from in FIG. 5. A functional block may be added to or removed from an RF Tx end and an RF Rx end shown in FIG. 5 according to a purpose.

A basic principle of an RF end in analog domain is to distribute partial power of a transmission signal, transform the distributed partial power to generate a replica signal of an actually received SI signal, and subtract the replica signal from a signal received by a reception antenna. In this case, in order to generate a signal similar to the received SI signal from the distributed transmission signal, it may be able to use various combinations of a true time delay, a phase shifter, and an attenuator.

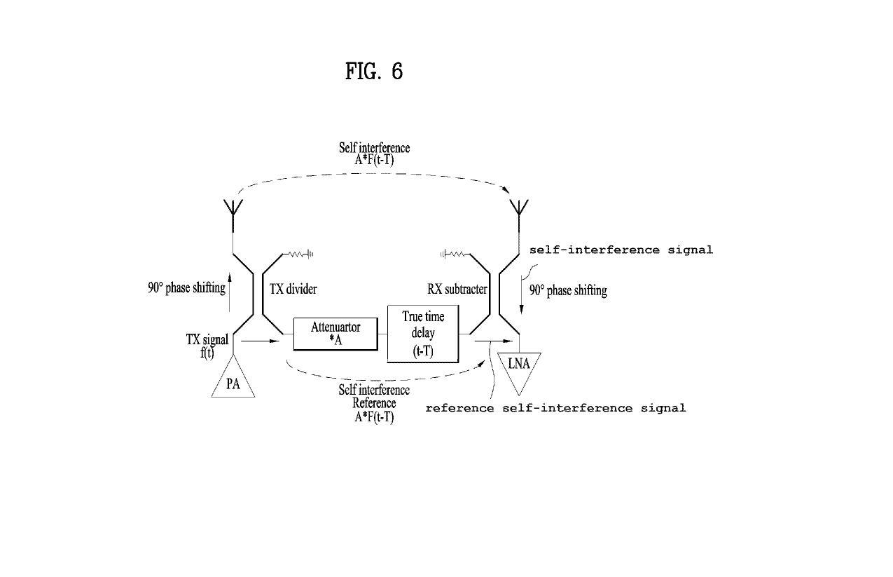

FIG. 6 is a diagram illustrating an example of an RF front-end structure, when a true time delay, a phase shifter, and an attenuator are connected in series to cancel self-interference in analog domain.

As illustrated in FIG. 6, according to a legacy self-interference cancellation method, self-interference is cancelled in a manner that a signal is extracted from a transmission signal via a directional coupler and a replica signal is generated using a true time delay, a phase shifter, and an attenuator. However, if the analog self-interference cancellation method is performed on a frequency selective fading channel, analog self-interference cancellation performance is degraded. Regarding this, it shall be described in detail in the following.

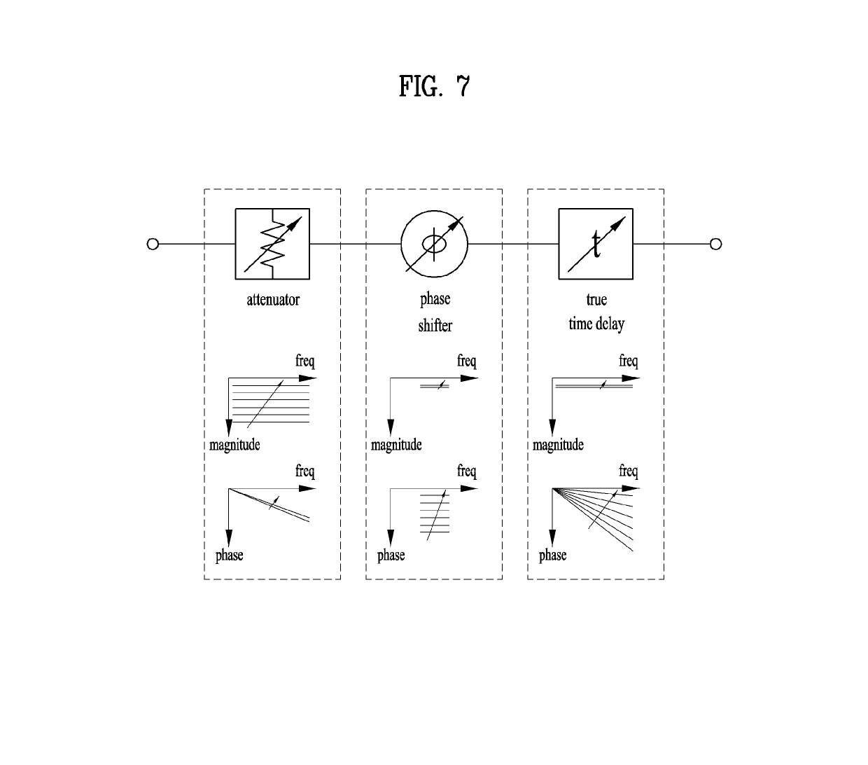

FIG. 7 is a diagram illustrating changing characteristics of a size and a phase according to changes of an attenuator, a phase shifter, and a true time delay.

As illustrated in FIG. 7, when a true time delay, a phase shifter, and an attenuator are used in series, it is a method appropriate for a frequency flat fading channel. If the attenuator is adjusted, a size of a signal is linearly changed over the entire band. If the phase shifter is adjusted, a phase of a signal is lineally changed over the entire band. If the true time delay is adjusted, a slope of a phase of a signal is lineally changed over the entire band. Therefore, if the true time delay, the phase shifter, and the attenuator are used in series, a size and a phase of a signal are linearly changed over the entire band and a slope of a (flat amplitude and phase-based SIC) phase is linearly changed over the entire band.

In a frequency flat fading channel environment in which multi-path does not exist, it may be able to expect sufficient self-interference cancellation performance using the aforementioned method (e.g., a method of using a true time delay, a phase shifter, and an attenuator in series). However, if the method is used in multi-path channel, a problem may occur depending on a situation.

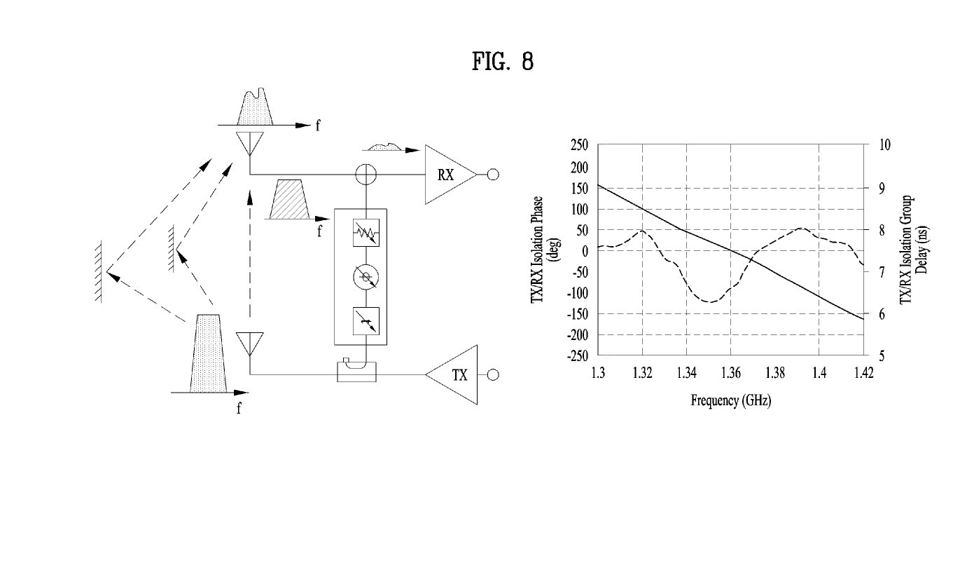

FIG. 8 is a diagram illustrating isolation phase (deg) and isolation group delay (ns) in multi-path channel environment.

As illustrated in FIG. 8, multi-path changes a slope (group delay) of a self-interference phase (SI phase) and, as mentioned in the foregoing method, the group delay can be handled by the true time delay. However, if there is multi-path of a strong backscatter, the group delay is considerably changed and negative delay may occur as a worst case. If the group delay is deviated from a region of the legacy true time delay, it is unable to process the group delay. For example, when self-interference cancellation is performed using a rat race coupler, if two signals of a reversal in phase transmitted from each antenna are received in phase in a manner of being reflected to surrounding object while a phase is not changed, SI may occur due to a multi-path of a strong backscatter. In this case, as mentioned in the foregoing description, it is unable to solve the SI using a legacy method only. And, since a frequency selective characteristic is reflected to a size as well due to the multi-path, performance using the legacy flat amplitude and phase-based SIC can be degraded.

Moreover, in case of wideband environment, since frequency selective characteristic occurs over a wideband compared to a narrow band, performance using the legacy flat amplitude and phase-based SIC can be degraded.

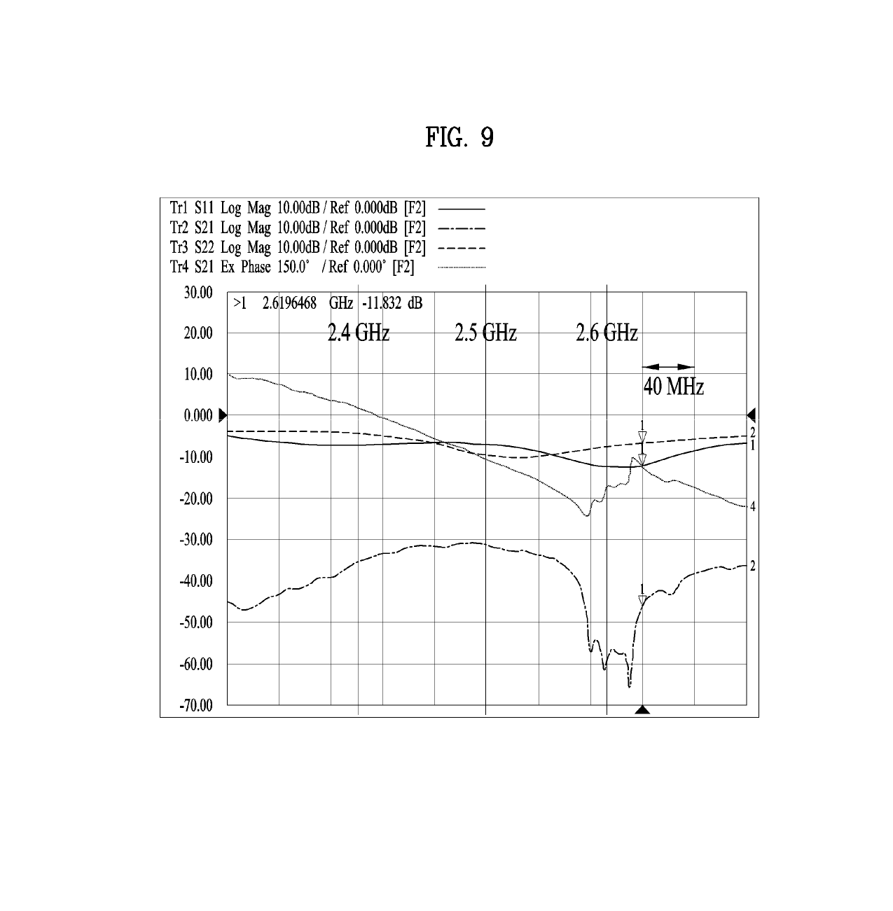

FIG. 9 is a diagram illustrating changes of a size and a phase according to a frequency change and self-interference cancellation (SIC) performance, when a rat race coupler (RRC) is used.

FIG. 9 illustrates a size (Tr1, Tr3) change according to a frequency, a phase (Tr4) change, and SIC performance (Tr2), when a rat race coupler is used. As illustrated in FIG. 9, since a frequency selective characteristic occurs in wideband environment, it is able to check that analog self-interference cancellation performance is degraded when the aforementioned method is used. Therefore, when FDR is operated in backscatter channel environment or wideband environment, if the analog self-interference cancellation is performed using the aforementioned method, self-interference cancellation performance is degraded. Hence, it is essential to develop an analog self-interference cancellation method appropriate for frequency selective fading channel environment.

The present invention relates to a method of performing analog self-interference cancellation appropriate for frequency selective fading channel environment capable of being occurred in backscatter channel environment or wideband environment. The present invention proposes a method of efficiently performing self-interference cancellation in an analog domain in a communication device (e.g., a UE or a base station) operating with an FDR type.

It is difficult to solve the aforementioned problem using the legacy 16 combinations between a fixed delay and an attenuator. As mentioned in the foregoing description, when a true time delay, a phase shifter, and an attenuator are connected in series, it is unable to reflect a frequency selective characteristic. In this case, the aforementioned problem can be solved by reflecting the frequency selective characteristic via a plurality of lines. A method of solving the problem is described in the following.

### Embodiment 1: Method of Performing Analog Self-Interference Cancellation Appropriate for Frequency Selective Fading Channel Environment by Combining a Plurality of Analog Signals Having a Different Time Delay Value

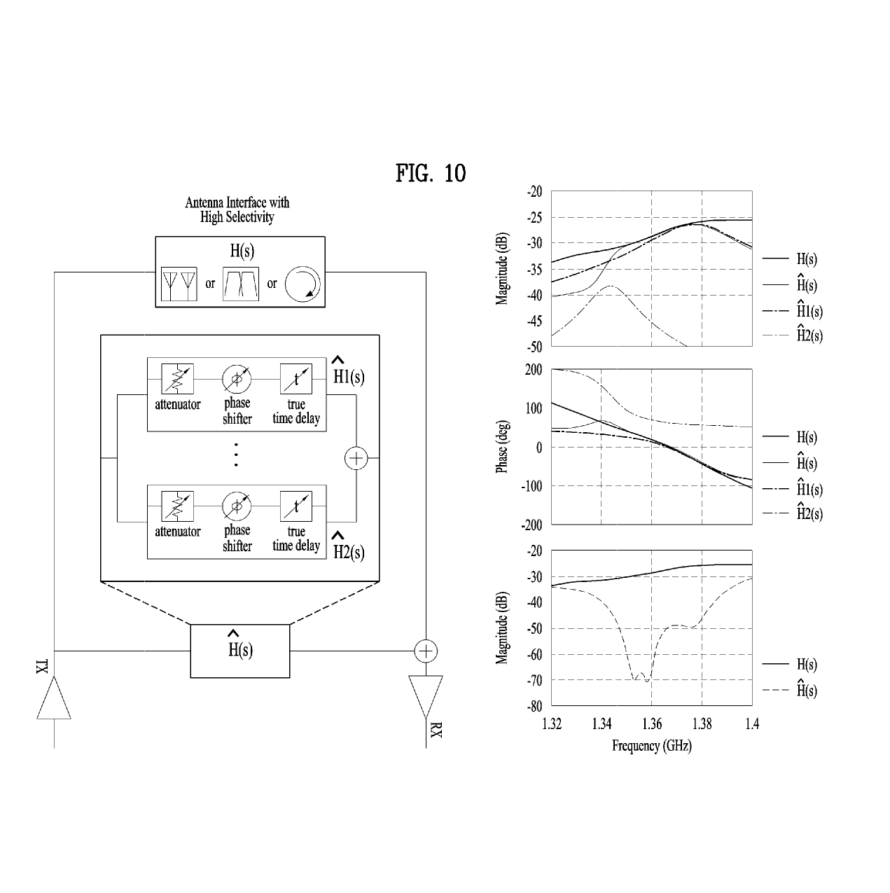

FIG. 10 is a diagram illustrating an example for a case of configuring a plurality of analog signals having a different delay value and an example of self-interference cancellation performance.

If a plurality of analog signals having a different time delay value are distributed from a transmission chain (Tx chain) at an RF end of a communication device and are matched with frequency selective fading channel environment, it is able to control a phase shifter and an attenuator of each of a plurality of the analog signals. FIG. 10 illustrates an example for a case that analog self-interference cancellation is performed over a wide frequency band by combining two analog signals by installing two lines. In this case, it may have more lines.

In FIG. 10, H(s) corresponds to a signal after antenna self-interference cancellation is performed (e.g., a signal after antenna self-interference cancellation is performed via a separated antenna, a circulator, or a rat race coupler), Ĥ2(s) and Ĥ2(s) correspond to signals transformed in a manner that an analog signal distributed from each transmission chain is passing through a true time delay and a phase shifter, and an attenuator, and Ĥ(s) corresponds to an analog signal value which is estimated by combining the Ĥ1(s) with the Ĥ2(s) to cancel analog self-interference.

In the left drawing of FIG. 10, Ĥ1(s) corresponds to a signal generated by replicating a self-interference signal for a signal distributed from a transmission chain to cancel an analog delf-interference signal. Hence, in the left drawing of FIG. 10, a box represented by Ĥ1(s) can be referred to as an (analog) self-interference signal replication unit (e.g., first self-interference signal replication unit). And, Ĥ2(s) also corresponds to a signal generated by replicating a self-interference signal for a signal distributed from a transmission chain to cancel an analog delf-interference signal. Hence, in the left drawing of FIG. 10, a box represented by Ĥ2(s) can be referred to as an (analog) self-interference signal replication unit (e.g., second self-interference signal replication unit).

Among the drawings positioned at the right side of FIG. 10, referring to the drawing positioned at the top and the drawing positioned at the center, graphs illustrate sizes and phases of Ĥ2(s), H1(s), H2(s), and H(s). Among the drawings positioned at the right side of FIG. 10, referring to the drawing positioned at the bottom, a graph illustrates H(s)—Ĥ(s) corresponding to analog self-interference cancellation performance according to a frequency band.

Similar to the legacy method, if a single analog replica signal is used (e.g., Ĥ(s)−Ĥ1(s) or Ĥ(s)−Ĥ2(s)), it is able to see that analog self-interference cancellation performance is obtained on a specific frequency only in frequency selective fading channel environment. In particular, as shown in FIG. 7, since a size and a phase are linearly changed according to changes of a true time delay, a phase shifter, and an attenuator, if values of the true time delay, the phase shifter, and the attenuator are matched on the basis of one frequency in the frequency selective fading channel environment, the values are not matched on another frequency. In particular, it is apparent that performance of analog self-interference cancellation is considerably degraded.

In particular, as mentioned in FIG. 10, if analog self-interference cancellation is performed based on a plurality of analog signals (e.g., Ĥ1(s) and Ĥ2(s)) having a different true time delay value, as shown in the graph of the drawing positioned at the bottom among the drawings of FIG. 10, it is able to see that performance of the analog self-interference cancellation is improved in the frequency selective fading channel environment.

### Embodiment 2: Method of Transmitting Multiple Tones to Calculate Configuration Values of a True Time Delay, a Phase Shifter, and an Attenuator in a Plurality of Analog Signals

If multiple tones (multiple pilot signals or multiple reference signals) are arranged with a prescribed interval, it is able to calculate configuration values of a true time delay, a phase shifter, and an attenuator in frequency selective fading channel environment.

As an example of arranging multiple tones with a prescribed interval, the multiple tones can be arranged by equally dividing a bandwidth. In this case, a part of tones can be arranged at a guard band. As a different example of arranging multiple tones with a prescribed interval, the multiple tones can be arranged by unequally dividing a bandwidth. In this case, a part of tones can be arranged at a guard band. As an example of calculating configuration values of a true time delay, a phase shifter, and an attenuator based on the multiple tones arranged with a prescribed interval, parameters can be sequentially controlled in a direction of improving performance of analog self-interference cancellation on the basis of initial values of the true time delay, the phase shifter, and the attenuator.

As a different example of calculating configuration values of a true time delay, a phase shifter, and an attenuator based on the multiple tones arranged with a prescribed interval, a value of the true time delay is preferentially measured and determined using the multiple tones on the basis of initial values of the phase shifter and the attenuator. Subsequently, parameters can be controlled in a direction of improving performance of analog self-interference cancellation on the basis of the initial values of the phase shifter and the attenuator.

In order to arrange multiple tones for measuring parameters with a specific interval in the frequency selective environment, it may periodically or aperiodically stop data transmission.

### Embodiment 3: Method of Performing Analog Self-Interference Cancellation by Selecting a Method from Among a Legacy Method and a Proposed Method by Determining Whether Channel Environment Corresponds to Frequency Selective Fading Channel Environment or not after Antenna/Analog Self-Interference is Cancelled

A communication device can determine whether channel environment corresponds to frequency selective fading channel environment or not via a value measured from the multiple tones. In a frequency flat fading channel environment, a legacy method (i.e., analog self-interference cancellation is performed using a single analog signal) is used. On the other hand, in a frequency selective fading channel environment, a method proposed by the present invention (i.e., analog self-interference cancellation is performed using a combination of a plurality of analog signals) is used.

For example, when the analog self-interference cancellation is performed using the legacy method, if a channel is changed to the frequency selective fading channel environment and analog self-interference cancellation performance is degraded, the analog self-interference cancellation can be performed using a combination of a plurality of analog signals. As a different example, when the analog self-interference cancellation is performed using the proposed method, if a channel is changed to the frequency flat fading channel environment and analog self-interference cancellation performance is degraded, the analog self-interference cancellation can be performed using the legacy method (i.e., analog self-interference cancellation is performed using a single analog signal).

The operation method according to the embodiment 3 may selectively operate only when a communication device (e.g., a base station or a UE) operates with an FDR type.

For example, a base station can operate with an FDR type only when a UE operating with the FDR type accesses the base station or a UE intending to perform DL reception and a UE intending to perform UL transmission are trying to perform communication at the same time. In this case, the method above can be selectively performed.

In general, since DL traffic is greater than UL traffic, in order for a UE to operate with an FDR type, it is necessary for a part of UEs intending to perform UL transmission to operate with the FDR type. In this case, the method above can be selectively performed. For example, a base station anticipates duration of an FDR operation of a UE via a buffer status report (BSR) of the UE. In order for the base station to receive necessary information from the UE at the timing preferred by the base station, the base station can trigger the UE to transmit control information via physical layer signaling or higher layer signaling.

Since it is able to include the examples for the proposed method as one of implementation methods of the present invention, it is apparent that the examples are considered as a sort of proposed methods. Although the embodiments of the present invention can be independently implemented, the embodiments can also be implemented in a combined/aggregated form of a part of embodiments. It may define a rule that an eNB informs a UE of information on whether to apply the proposed methods (or, information on rules of the proposed methods) via a predefined signal (e.g., physical layer signal or higher layer signal).

According to one embodiment of the present invention, when a frequency selective characteristic of self-interference occurs according to channel environment or a frequency selective characteristic of self-interference occurs over a wideband, it is able to efficiently cancel the self-interference, thereby considerably improving communication performance in FDR environment.

The above-described embodiments correspond to combinations of elements and features of the present invention in prescribed forms. And, the respective elements or features may be considered as selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

A method of canceling self-interference signal in FDR environment and a communication device therefor can be industrially used in various wireless communication systems including 3GPP LTE/LTE-A system, 5G communication system, and the like.

What is claimed is:

1. A communication device for canceling a self-interference signal in (Full Duplex Radio (FDR) environment, the communication device comprising:
a distributor configured to distribute signals from a transmission chain to a reception chain via a plurality of lines;
a first self-interference signal replication unit configured to generate a self-interference replication signal for a signal distributed via a first line by the distributor among a plurality of the lines;
a second self-interference signal replication unit configured to generate a self-interference replication signal for a signal distributed via a second line by the distributor among a plurality of the lines; and
a self-interference cancellation unit configured to perform self-interference cancellation in a manner of subtracting the signal generated by the first self-interference signal replication unit and the signal generated by the second self-interference signal replication unit from the signals distributed by the distributor.

2. The communication device of claim 1, wherein each of the first self-interference signal replication unit and the second self-interference signal replication unit contains an attenuator, a phase shifter, and a true time delay, and
wherein a time delay value of a true time delay contained in the first self-interference signal replication unit is different from a time delay value of a true time delay contained in the second self-interference signal replication unit.

3. The communication device of claim 1, further comprising:
a processor configured to determine whether to replicate a plurality of self-interference signals for the signals distributed via a plurality of the lines.

4. The communication device of claim 3, wherein the processor is configured to determine based on whether the FDR environment corresponds to a frequency selective fading channel characteristic.

5. The communication device of claim 3, further comprising the transmission chain configured to transmit multiple tones,
wherein the processor is configured to determine whether to replicate the plurality of self-interference signals based on channel measurement for the multiple tones.

6. A method for canceling a self-interference signal by a communication device in Full Duplex Radio (FDR) environment, the method comprising:
distributing signals from a transmission chain to a reception chain of an RF end via a plurality of lines;
performing attenuation, phase shift, and time delay on the distributed signals in a first line among a plurality of the lines;
performing attenuation, phase shift, and time delay on the distributed signals in a second line among a plurality of the lines; and
performing self-interference cancellation in a manner of subtracting a first signal on which the attenuation, the phase shift, and the time delay are performed and a second signal on which the attenuation, the phase shift, and the time delay are performed from the distributed signals.

7. The method of claim 6, wherein a value of the time delay in the first line is different from a value of the time delay in the second line.

8. The method of claim 6, further comprising:
determining whether the attenuation, the phase shift, and the time delay are performed on the distributed signal in a plurality of the lines or a single line.

9. The method of claim 8, wherein the determining is performed based on whether or not the FDR environment corresponds to a frequency selective fading channel characteristic.

10. The method of claim 9, wherein whether the FDR environment corresponds to the frequency selective fading channel characteristic is determined based on channel measurement for multiple tones transmitted by the communication device.
